(19) United States
(12) Patent Application Publication
(10) Pub. No.: US 2026/0352400 A1
(43) Pub. Date: Nov. 5, 2026

(54) UNIFIED FRAME STRUCTURE FOR TRAINING AND DATA MODE COMMUNICATION

(71) Applicant: Infineon Technologies Americas Corp., El Segundo, CA (US)

(72) Inventors: Ragnar Jonsson, Aliso Viejo, CA (US); Seid Alireza Razavi Majomard, Belmont, CA (US)

(73) Assignee: Infineon Technologies Americas Corp., El Segundo, CA (US)

(21) Appl. No.: 19/661,386

(22) Filed: Apr. 28, 2026

Related U.S. Application Data
(60) Provisional application No. 63/797,746, filed on Apr. 30, 2025.

(51) Int. Cl. H04L 5/00; H04L 1/00

(52) U.S. Cl. CPC H04L 5/0048; H04L 1/0003; H04L 1/0057

(57) ABSTRACT

A system comprises a transmitter that generates frames using a unified frame structure for both a training mode and a data mode. The unified frame structure comprises a plurality of encoded blocks, and the transmitter uses a same modulation scheme during both modes. During training mode, at least one encoded block contains an information field encoded as a control block with a training-mode-specific block identifier. During data mode, the transmitter generates data frames with data content in the encoded blocks. A receiver receives the frames and detects a transition from training mode to data mode based on detecting a content change in the encoded blocks. Methods and apparatuses for link synchronization are also provided.

### CROSS-REFERENCE TO RELATED APPLICATIONS

This application claims priority to U.S. Provisional Application No. 63/797,746, titled “ACT/GMSLE Training Frame and Training Sequence,” filed Apr. 30, 2025, which is hereby incorporated by reference in its entirety.

### FIELD OF INVENTION

The present disclosure relates to communication systems employing physical layer training sequences, and more particularly to a unified frame structure for training and data mode communication that enables simplified state machine transitions and hardware reuse by structuring training frames as a special case of data mode frames.

### BACKGROUND

Communication systems employing physical layer devices often utilize training sequences during link establishment to enable receivers to synchronize with transmitters and to allow link partners to exchange capability and status information before transitioning to normal data transmission. In many communication protocols, the training phase and the data transmission phase employ different frame structures, encoding schemes, or modulation formats. This structural difference between training and data modes can introduce complexity in the physical layer implementation, as the transition between modes may require coordination mechanisms, multiple processing paths, and additional state machine states to manage the changeover. Designers continue to develop approaches for simplifying the training-to-data transition and reducing implementation complexity in physical layer devices in communication system designs.

### BRIEF DESCRIPTION OF THE DRAWINGS

Non-limiting and non-exhaustive examples are described with reference to the following figures.

FIG. 1 illustrates a block diagram of a system for communication between a transmitter and a receiver, according to aspects of the present disclosure.

FIG. 2 illustrates a block diagram of an architecture for a communication system, according to an embodiment.

FIG. 3 depicts a format of an information field training structure, according to aspects of the present disclosure.

FIG. 4 depicts a format of an information field countdown structure, according to an embodiment.

FIG. 5 depicts a view comparing a training frame and a data mode frame in a unified frame structure, according to aspects of the present disclosure.

FIG. 6 depicts a view of an encoded block structure, according to an embodiment.

FIG. 7 depicts a view of a control block structure used for encoding an information field during training mode, according to aspects of the present disclosure.

FIG. 8 illustrates a state flow comparing a simplified PHY control state diagram with a conventional PHY control state diagram, according to an embodiment.

FIG. 9 illustrates a state diagram for a PHY control process, according to aspects of the present disclosure.

FIG. 10 depicts a view illustrating a transition between a training mode frame and a data mode frame, according to an embodiment.

FIG. 11 illustrates a flowchart of a method for generating and transmitting frames using a unified frame structure, according to aspects of the present disclosure.

### DETAILED DESCRIPTION

The present disclosure relates to a unified frame structure for training and data mode communication. In various embodiments, a transmitter generates frames using a unified frame structure for both a training mode and a data mode. The unified frame structure comprises a plurality of encoded blocks, and the transmitter uses the same modulation scheme during both modes. During training mode, at least one of the encoded blocks contains an information field encoded as a control block with a training-mode-specific block identifier. The training-mode-specific block identifier comprises a unique code value within the encoded block that identifies the type of information the block contains, allowing the receiver to distinguish training frames from data frames. During data mode, the encoded blocks carry data content. A receiver receives the generated frames and detects a transition from training mode to data mode based on observing a change in content of the encoded blocks. The disclosure also encompasses embodiments of a transmitter comprising a frame generator configured to generate frames using the unified frame structure for both training and data modes, maintaining consistent modulation and encoding approaches across both operational modes. The disclosed subject matter may be implemented in physical-layer communication circuitry and frame-processing logic and may improve operation of communication hardware by reducing state-machine complexity, reusing encoding and framing circuitry across operational modes, and enabling transition detection based on received frame content.

In communication systems, when two devices first establish a connection, the devices undergo a training mode during which the devices learn about each other’s capabilities and synchronize their operations. A frame comprises a discrete unit or packet of information sent over a communication link, structured according to a defined format that allows the receiver to interpret its contents. The training process is analogous to two people establishing a common language or protocol before having a conversation, where both parties agree on how to communicate before meaningful information can be exchanged. During training mode, the transmitter sends known patterns and information that allow the receiver to adjust its internal settings, such as timing recovery and signal equalization, to properly interpret incoming signals. The receiver also communicates its status back to the transmitter to indicate when the receiver has successfully completed its adjustments and is ready to receive actual data. Once both link partners have confirmed that training is complete and the communication channel is properly configured, the system transitions to data mode, during which the transmitter sends actual user data rather than training patterns. The transition from training mode to data mode represents a critical point in link establishment, as the system coordinates this changeover to ensure that the receiver is prepared to correctly interpret the data frames that follow the training frames.

The way the training-to-data transition is implemented has significant implications for the complexity and efficiency of the physical layer design. Conventional approaches to managing this transition have introduced various mechanisms for coordinating the changeover between link partners, including countdown sequences, modulation switching procedures, and explicit synchronization protocols. These mechanisms, while functional, add overhead to the physical layer implementation in terms of state machine complexity, hardware resources, and link establishment time.

Communication systems that employ physical layer training sequences face significant challenges arising from structural differences between training mode and data mode operations. In conventional implementations, the training process and the normal data transmission process employ fundamentally different frame structures. The training frame structure is purpose-built for the training phase and does not share a common format with the data mode frame structure. This architectural disparity introduces several deficiencies that increase implementation complexity and resource requirements.

One deficiency in conventional approaches relates to the encoding of training information. In existing systems, an information field that conveys receiver status, control information, and capability data is encoded by XORing the information field directly with a portion of a scrambled training sequence at a defined position within the training frame. XORing comprises a bitwise logical operation that outputs a one when two binary inputs differ and a zero when they match. A scrambled training sequence comprises a predetermined pattern of bits that has been randomized to improve signal characteristics during transmission. This encoding approach differs fundamentally from the block-based encoding used during data mode, preventing reuse of encoding hardware and logic between the two operational modes. Block-based encoding comprises an encoding approach, such as 64B/65B encoding, that organizes data into discrete blocks, where each block includes a control indicator bit that distinguishes whether the block contains data or control information.

Another deficiency in conventional approaches relates to the coordination required during mode transitions. In existing systems, an explicit countdown mechanism is employed to synchronize the transition between training mode and data mode. The countdown provides advance notification to the receiver that the transmitter will soon switch from transmitting training frames to transmitting data frames. This countdown mechanism requires additional state machine states and coordination logic, increasing implementation complexity. The countdown approach also requires both link partners to maintain synchronized counters, adding to the hardware requirements and potential sources of synchronization errors.

A further deficiency arises from modulation switching between training and data modes. Conventional systems often use one modulation scheme during training, such as PAM2, and a different modulation scheme during data mode, such as PAM4. PAM2 comprises a simpler two-level signaling method, while PAM4 comprises a more complex four-level signaling method that can carry more data. When the modulation scheme changes between training and data modes, the countdown provides the receiver with advance notice to reconfigure its signal detection and equalization functions for the new modulation format.

This modulation reconfiguration requires additional state machine states. State machine states comprise distinct operational conditions within control logic that determine how the system responds to inputs and transitions between modes. The additional states include a transmitter switch state (or “TX switch state”) for managing the modulation transition and a physical coding test state (or “PCS test state”) for verifying successful transition completion. The PCS test state comprises a physical coding sublayer verification state that confirms the encoding and decoding functions are operating correctly after a mode change.

These deficiencies collectively result in a state machine architecture that includes multiple intermediate states between training and data transmission, including countdown, TX switch, and PCS test states. The state machine architecture comprises the overall design and organization of the control logic that manages transitions between different operational states in a communication system. The presence of these additional states increases the complexity of physical layer implementations, requires additional hardware resources, complicates verification and testing procedures, and can increase the time required for link establishment. Physical layer implementations comprise the hardware and logic circuits that transmit and receive raw bit streams over the physical medium. Link establishment comprises the process by which two communication devices configure and synchronize their connection before exchanging user data. Furthermore, the distinct frame structures prevent hardware reuse between training and data modes, increasing silicon area and implementation cost. Silicon area comprises the physical chip space required to implement the logic circuits. Accordingly, there exists a need for approaches that address these deficiencies by simplifying the training-to-data transition and enabling hardware reuse between training and data mode operations.

Embodiments of the present disclosure address the deficiencies of conventional systems by providing a unified frame structure wherein the training frame is structured as a special case of the data mode frame. Rather than employing fundamentally different frame structures for training and data transmission, the disclosed embodiments use the same frame structure for both modes, with the training frame differing from the data frame only in content, not structure. This unified approach enables hardware reuse between training and data modes, as the same framing logic and encoding paths can be utilized for both operational modes, thereby reducing silicon area and implementation cost.

The disclosed embodiments further overcome the deficiency of conventional information field encoding by encoding the information field within a 64B/65B control block with the 65th bit set to one and a distinct block identifier that is different from block identifiers used in data mode. The 65th bit set to one indicates that the block contains control information rather than data. The distinct block identifier comprises a unique code value that identifies the type of block. This approach replaces the conventional technique of XORing the information field directly with a scrambled training sequence, and instead leverages the same block-based encoding structure used during data mode transmission. By encoding the information field within the standard 64B/65B block format, the disclosed embodiments enable the training information to be carried within the same frame structure used for data mode, facilitating hardware reuse and simplifying the encoding process.

The disclosed embodiments address the deficiency of explicit countdown coordination by enabling content-based transition detection. The receiver detects the transition from training mode to data mode by observing a change in content of the encoded blocks, such as the absence of the training-mode-specific block identifier in a block position that contained an information field during training mode. This approach allows the receiver to determine that a transition has occurred based on observed frame content rather than advance notification through a countdown field. In some embodiments, a countdown field may optionally be retained for compatibility with existing implementations while the receiver remains capable of detecting the transition based on observed block content.

The disclosed embodiments also address the deficiency arising from modulation switching by using the same modulation scheme during both training and data modes. By maintaining consistent modulation throughout training and data transmission, the disclosed embodiments eliminate the need for modulation reconfiguration and the associated TX switch state that would otherwise be required to coordinate the transition from one modulation format to another. In some embodiments, this consistent modulation approach, combined with the unified frame structure and content-based transition detection, enables a simplified state machine architecture that transitions directly from a training state to a data transmission state without requiring intermediate countdown, TX switch, or PCS test states. The elimination of these three intermediate states reduces implementation complexity, decreases hardware resource requirements, simplifies verification and testing procedures, and can reduce the time required for link establishment.

The unified frame structure for training and data mode communication of the present disclosure provides several technical advantages arising from the disclosed structural and operational features of the transmitter, receiver, frame format, and transition detection logic. First, the structuring of the training frame as a special case of the data mode frame enables hardware reuse between training and data modes, as the same framing logic, encoding paths, and 64B/65B block processing circuitry can be utilized for both operational modes, thereby reducing silicon area and implementation cost. Second, the encoding of the information field within a 64B/65B control block with a training-mode-specific block identifier allows the training information to be carried within the same frame structure used for data mode, eliminating the need for separate encoding logic that would otherwise be required for XORing the information field with a scrambled training sequence. Third, the content-based transition detection mechanism, wherein the receiver detects the transition from training mode to data mode by observing the absence of the training-mode-specific block identifier, eliminates the need for explicit countdown synchronization between link partners, simplifying the coordination required during mode transitions. Fourth, the use of the same modulation scheme during both training and data modes eliminates the need for modulation reconfiguration circuitry and the associated TX switch state, reducing power consumption and transition latency. Fifth, the simplified state machine architecture that transitions directly from a training state to a data transmission state without requiring intermediate countdown, TX switch, or PCS test states reduces implementation complexity by eliminating three states from the PHY control state machine, which directly translates to reduced logic complexity, faster link establishment, and simplified compliance testing. Sixth, the unified frame structure approach provides enhanced interoperability by maintaining structural consistency between training and data frames, reducing the potential for synchronization errors during mode transitions. These technical advantages collectively contribute to a physical layer implementation that achieves simplified training-to-data transitions, reduced hardware resource requirements, and improved link establishment performance. The following figures illustrate various aspects of these embodiments and their technical advantages. Although certain embodiments are described as combining a unified frame structure, content-based transition detection, use of a same modulation scheme in training mode and data mode, and direct state-machine transition from training to data transmission, these features need not all be present in every embodiment. In some embodiments, one or more of these features may be used independently or in any suitable combination with one or more other disclosed features.

As used herein, the term “unified frame structure” refers to a frame format that maintains the same structural organization for both training mode and data mode operations. Training frames and data frames share the same arrangement of encoded blocks, reserved fields, and forward error correction parity fields. The distinction between training and data frames is determined by the content within the encoded blocks rather than by differences in the frame structure itself. As used herein, the term “encoded blocks” refers to discrete units of data that have been processed through an encoding scheme, such as 64B/65B encoding. Each block comprises a fixed number of bits organized according to a defined format that may include control indicator bits, block identifiers, and payload fields. As used herein, the term “64B/65B” refers to a block encoding scheme in which 64 bits of payload data are encoded into a 65-bit block, where the additional bit serves as a control indicator that distinguishes whether the block contains data content or control information. As used herein, the term “modulation scheme” refers to a method for encoding digital information onto a physical signal for transmission over a communication medium, including but not limited to pulse amplitude modulation techniques such as PAM2 and PAM4. As used herein, the term “forward error correction parity bits” refers to redundant bits added to transmitted data that enable a receiver to detect and correct transmission errors without requiring retransmission, including parity bits generated through Reed-Solomon encoding or other forward error correction algorithms.

As used herein, the term “predetermined data patterns” refers to known sequences of data values that are established prior to transmission and are recognizable by a receiver, including patterns such as all-zero data blocks used during training mode to facilitate receiver synchronization. As used herein, the term “status bits” refers to binary indicators within an information field that communicate operational states or conditions between link partners, such as training completion readiness or receiver synchronization status. As used herein, the term “local receiver status indicator” refers to a status bit that is set by a device to indicate that its local receiver has completed training operations and is ready to transition to data mode. As used herein, the term “state machine” refers to a control logic construct that manages transitions between a finite number of defined operational states based on input conditions and current state, governing the behavior of a physical layer device during link establishment and data transmission.

As used herein, the term “TX” refers to a transmitter or transmission, depending on context. As used herein, the term “PCS” refers to the physical coding sublayer, which is a sublayer of the physical layer responsible for encoding and decoding data for transmission over a communication medium. As used herein, the term “PHY” refers to the physical layer, which is the lowest layer of a communication system responsible for transmitting and receiving raw bit streams over a physical medium. As used herein, the term “countdown state” refers to an intermediate state in a conventional state machine during which a transmitter decrements a counter to provide advance notification to a receiver of an impending mode transition. As used herein, the term “TX switch state” refers to an intermediate state in a conventional state machine during which a transmitter changes its modulation format or transmission mode. As used herein, the term “PCS test state” refers to an intermediate state in a conventional state machine during which the physical coding sublayer verifies that encoding and decoding functions are operating correctly after a mode change. As used herein, the term “common encoding path” refers to shared circuitry and logic that processes both training frames and data frames using the same encoding operations. As used herein, the term “common framing logic” refers to shared circuitry that assembles both training frames and data frames according to the unified frame structure. As used herein, the term “control indicator bit” refers to a single bit within an encoded block, such as the 65th bit in 64B/65B encoding, that distinguishes whether the block contains data content or control information. As used herein, the term “link partners” refers to two communication devices connected via a communication link that exchange information to establish and maintain a communication session.

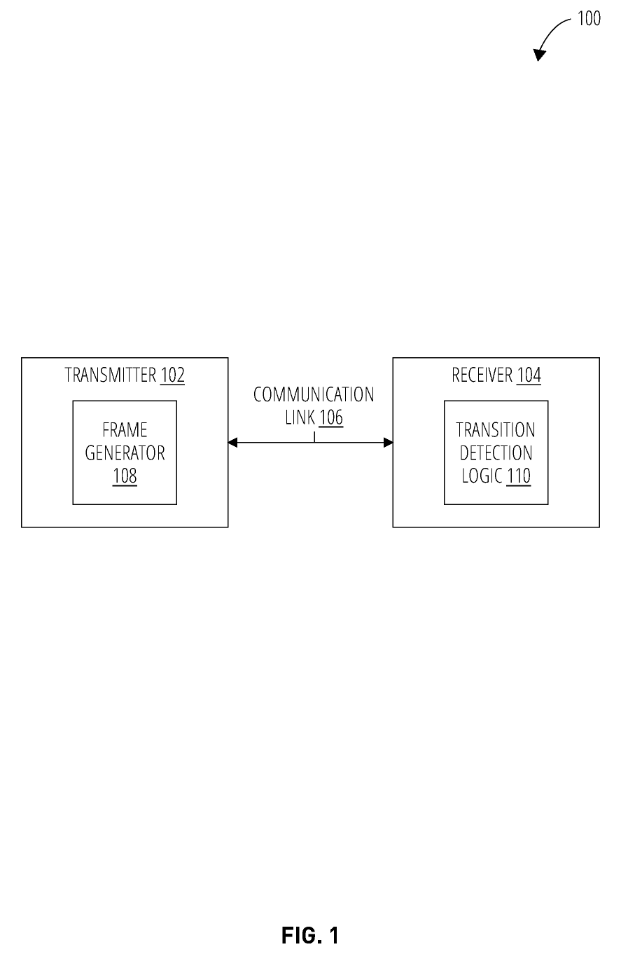

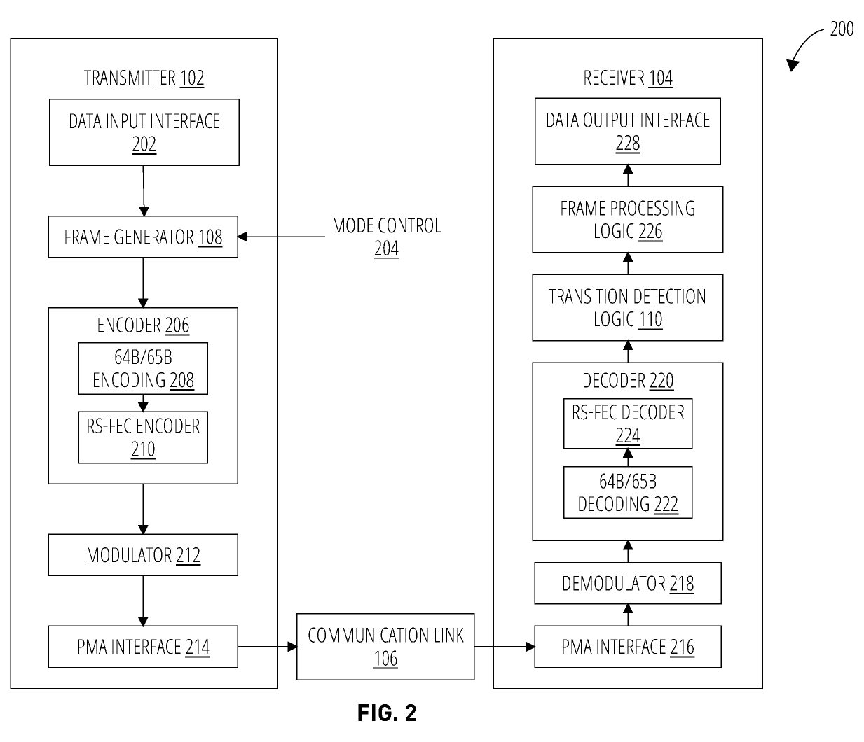

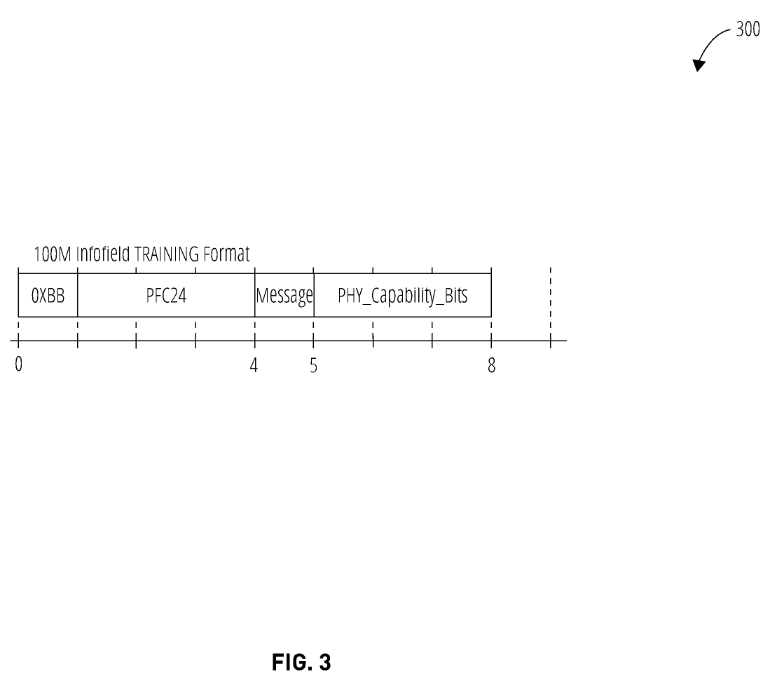

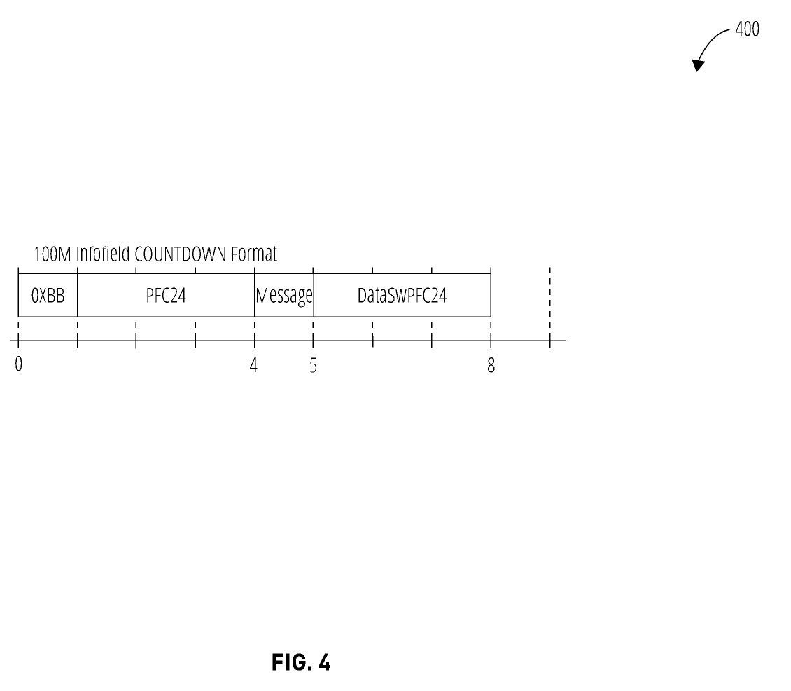

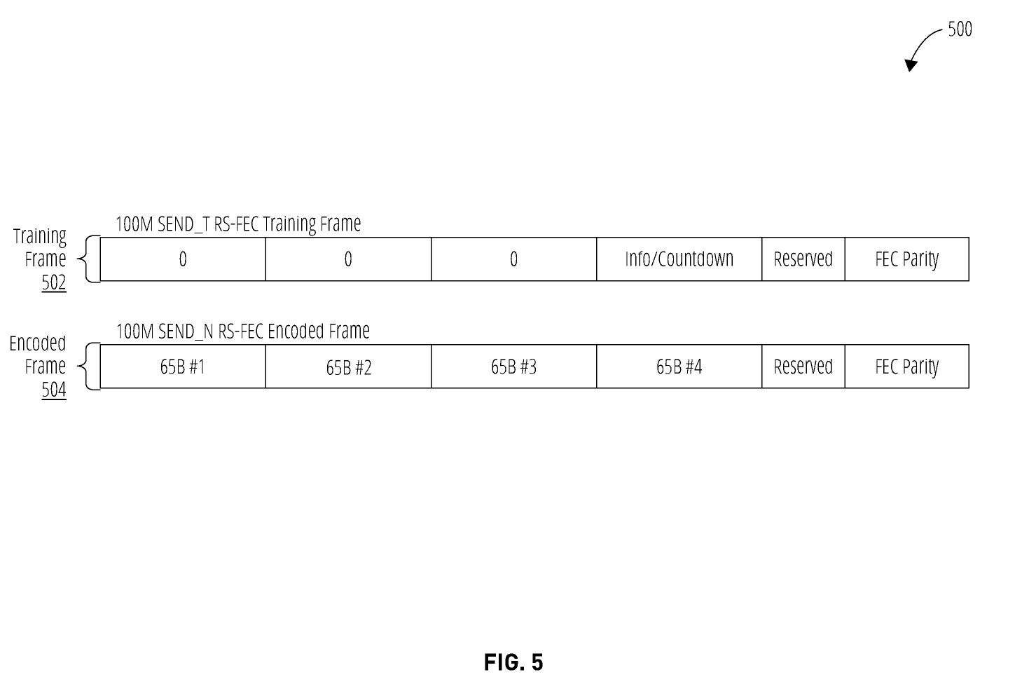

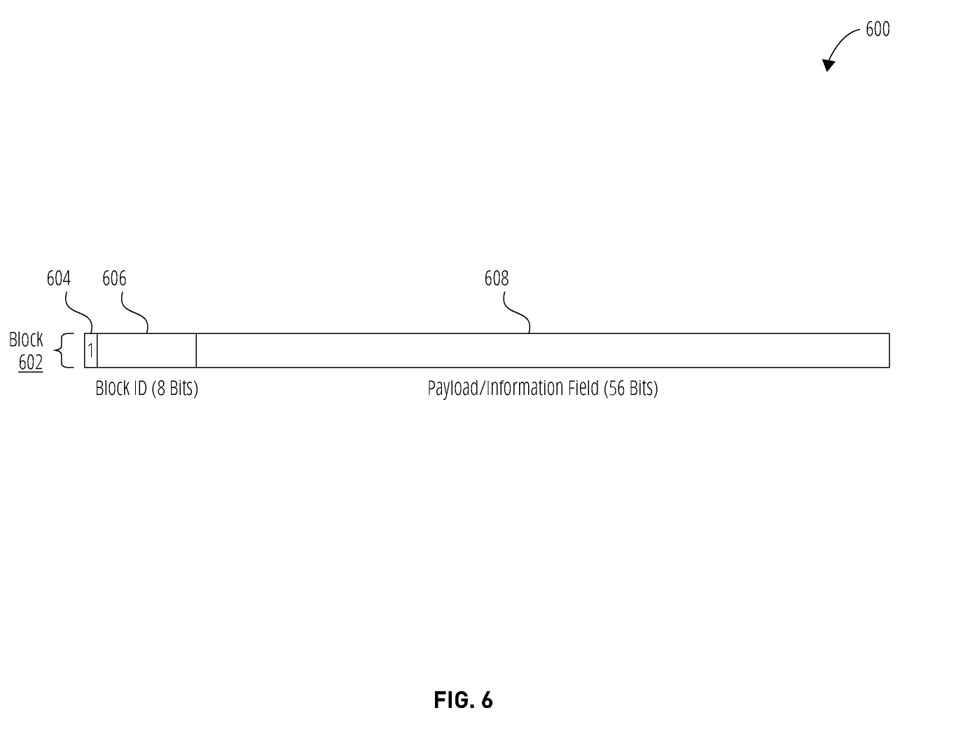

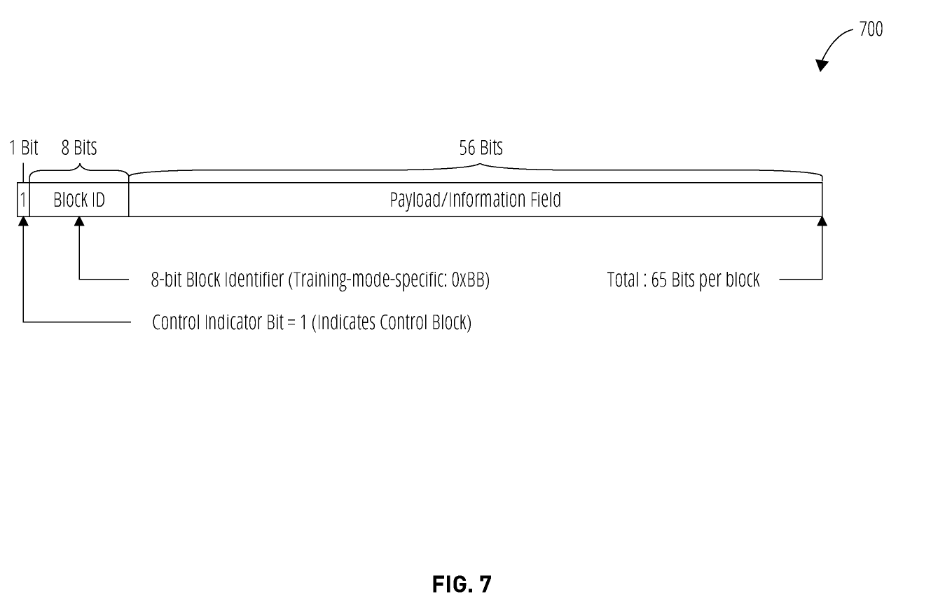

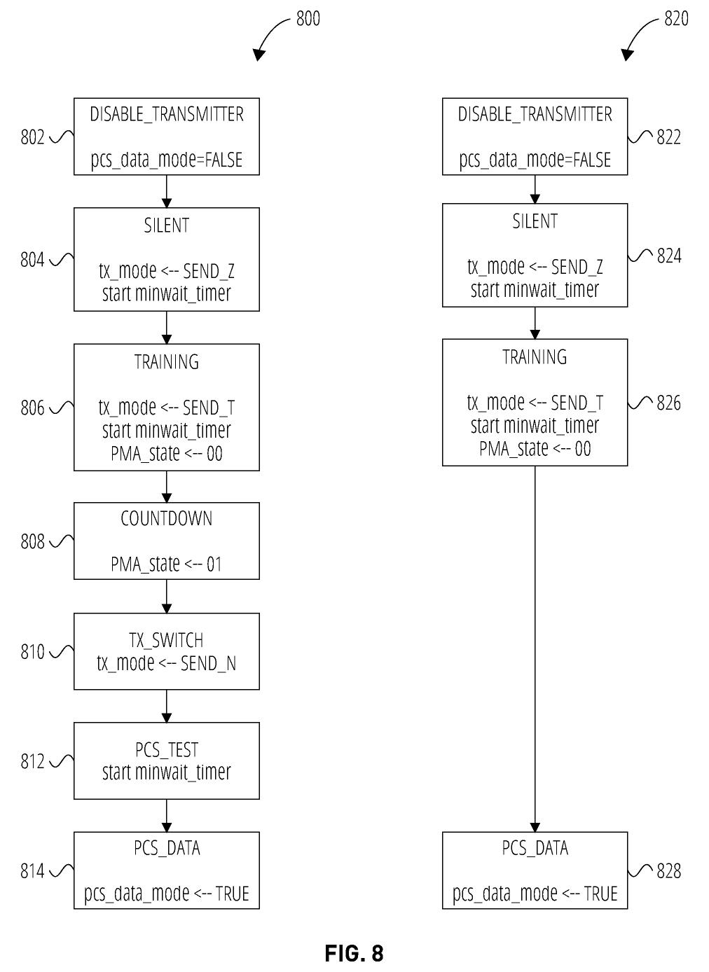

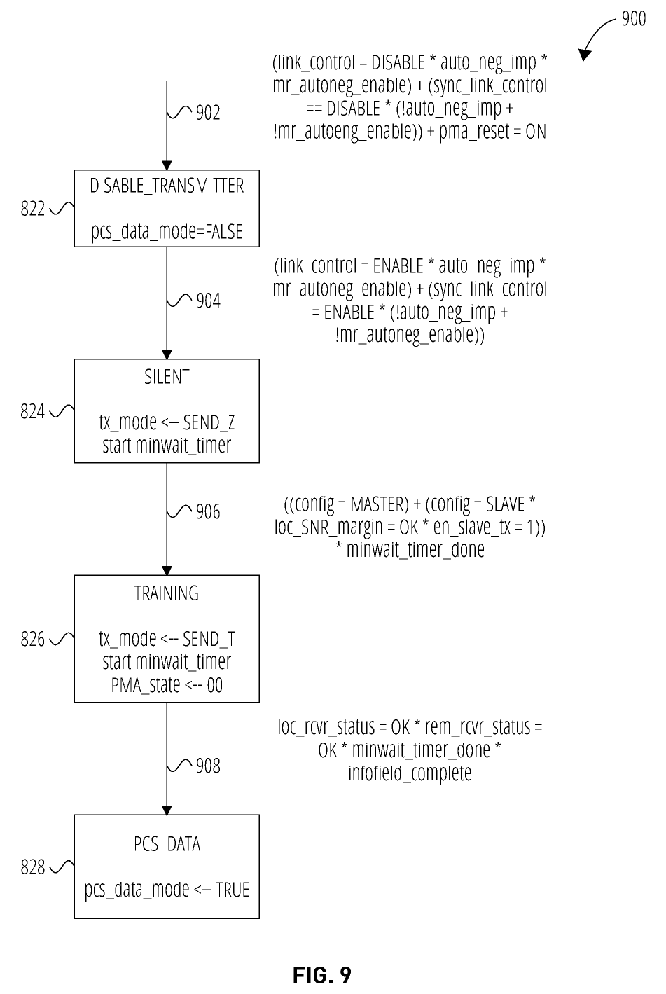

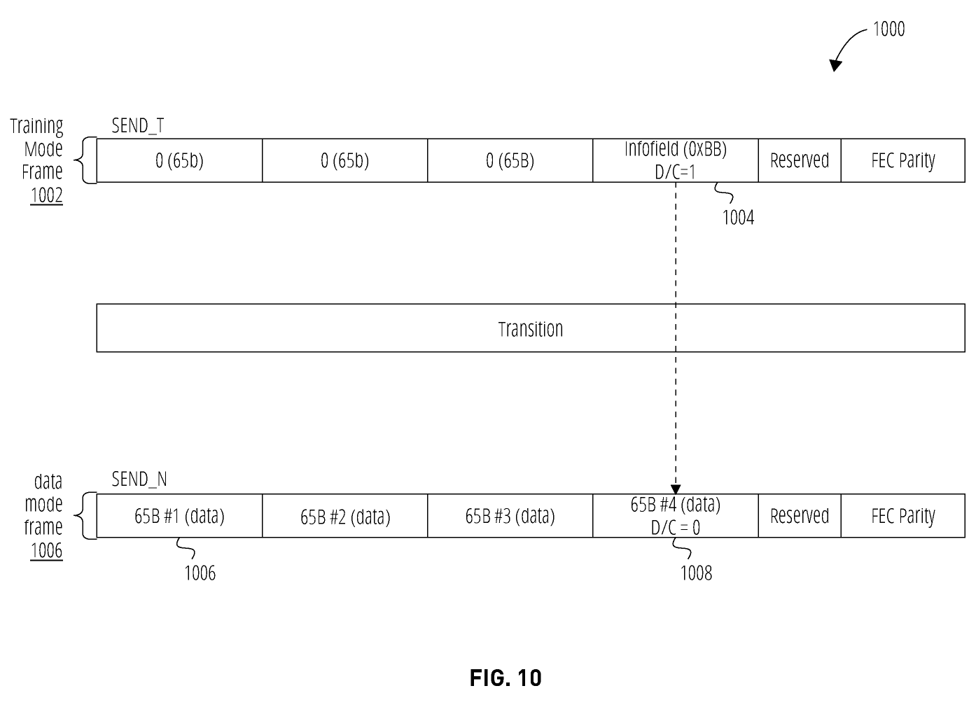

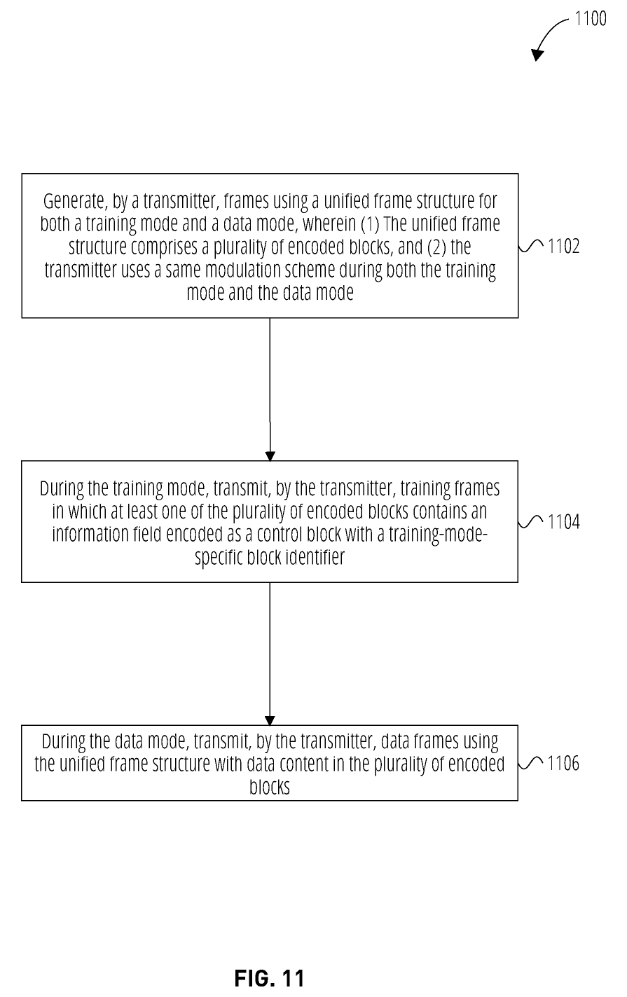

The following description refers to the accompanying drawings, which illustrate various aspects of the unified frame structure for training and data mode communication. FIG. 1 illustrates an exemplary system comprising a transmitter and a receiver connected via a communication link, showing the frame generator and transition detection logic components. FIG. 2 depicts an architecture of the communication system, illustrating the internal components of the transmitter and receiver including the encoder with 64B/65B Encoding and RS-FEC Encoder, the modulator, the decoder with corresponding decoding components, and the frame processing logic. FIGS. 3 and 4 show the information field formats for training and countdown modes, respectively, illustrating the structure of the information field encoded within the 64B/65B control block. FIG. 5 depicts a view comparing a training frame and a data mode frame, demonstrating how both frame types share the unified frame structure while differing only in content. FIGS. 6 and 7 illustrate the encoded block structure and the control block structure used for encoding an information field during training mode, showing the arrangement of the control indicator bit, block identifier, and payload. FIG. 8 presents a state flow comparing the simplified PHY control state diagram enabled by the unified frame structure with a conventional PHY control state diagram, illustrating the elimination of the countdown state, TX switch state, and PCS test state. FIG. 9 illustrates a state diagram for a PHY control process, showing the direct transition from the training state to the data transmission state. FIG. 10 depicts a view of the transition between a training mode frame and a data mode frame, illustrating how the receiver detects the mode transition based on the change in content of the encoded blocks. FIG. 11 illustrates a flowchart of a method for generating and transmitting frames using the unified frame structure.

Referring to FIG. 1, a system 100 for communication between a transmitter 102 and a receiver 104 is illustrated. The system 100 may be implemented as a physical layer device for point-to-point communication links. In some embodiments, the system 100 may comprise a 100M ACT/GMSLE (100 Megabit Automotive Compliance Test / Gigabit Multimedia Serial Link Ethernet) automotive Ethernet PHY suitable for automotive camera, display, and sensor applications. A communication link 106 connects the transmitter 102 to the receiver 104 and enables the transfer of frames between the transmitter 102 and the receiver 104. In various embodiments, the communication link 106 may provide bidirectional communication capability, allowing the transmitter 102 and the receiver 104 to exchange information during both training mode and data mode operations.

In some embodiments, the transmitter 102 may comprise an automotive camera module configured to capture video data and transmit the video data to a central processing unit within a vehicle, and the receiver 104 may comprise the central processing unit configured to receive and process the video data for display or analysis purposes. In such embodiments, the communication link 106 may comprise a shielded twisted pair cable that connects the camera module to the central processing unit, providing a physical medium for transmitting frames between the transmitter 102 and the receiver 104. In other embodiments, the transmitter 102 may comprise a sensor module, such as a radar or LiDAR unit, configured to generate sensor data, and the receiver 104 may comprise an advanced driver assistance system controller configured to process the sensor data for collision avoidance or autonomous driving functions. In such embodiments, the communication link 106 may comprise a single twisted pair Ethernet connection configured to carry the sensor data between the sensor module and the controller. In still other embodiments, the transmitter 102 may comprise a head unit or infotainment system configured to generate display data, and the receiver 104 may comprise a display panel located in a vehicle dashboard or rear seat entertainment system. In such embodiments, the communication link 106 may comprise an unshielded twisted pair cable routed through a vehicle wiring harness.

The transmitter 102 may be configured to generate frames using a unified frame structure for both a training mode and a data mode. The unified frame structure may comprise a plurality of encoded blocks, as described previously. In various embodiments, the transmitter 102 may use a same modulation scheme during both the training mode and the data mode, thereby maintaining consistent signal characteristics throughout link establishment and data transmission phases. The transmitter 102 may include a frame generator 108 configured to generate frames using the unified frame structure for both training mode and data mode operations. The frame generator 108 may be configured to use a same modulation scheme for generating frames during both the training mode and the data mode. In some embodiments, the frame generator 108 may use a common encoding path and common framing logic for generating both training frames and data frames, thereby enabling hardware reuse between training and data mode operations. By utilizing the common encoding path and common framing logic, the frame generator 108 may reduce silicon area requirements and implementation cost compared to conventional approaches that employ separate encoding and framing circuitry for training and data modes. In various embodiments, the unified frame structure may enable the same hardware to be used for generating both training frames and data frames, as the training frame is structured as a special case of the data mode frame. In such embodiments, separate framing logic for training mode may no longer be necessary, which may produce a measurable reduction in hardware resources required for PHY implementation.

The receiver 104 may be configured to receive the generated frames from the transmitter 102 via the communication link 106. The receiver 104 may include transition detection logic 110 configured to detect a transition from the training mode to the data mode based on observing a change in content of at least one encoded block. The transition detection logic 110 may be configured to monitor the content of the encoded blocks within received frames to determine when the transmitter 102 has transitioned from transmitting training frames to transmitting data frames. In some embodiments, the transition detection logic 110 may detect the transition by observing the absence of a training-mode-specific block identifier in the position that contained an information field during training mode. This content-based transition detection mechanism may eliminate the need for explicit countdown synchronization between the transmitter 102 and the receiver 104.

In an exemplary implementation, the system 100 may be deployed within an automotive vehicle where the transmitter 102 comprises a high-definition camera module mounted on the vehicle exterior for surround-view monitoring, and the receiver 104 comprises an electronic control unit located in the vehicle cabin that processes the camera feed for parking assistance display. The communication link 106 may comprise a single twisted pair cable routed through the vehicle wiring harness, connecting the camera module to the electronic control unit. The frame generator 108 within the camera module may generate training frames during initial link establishment when the vehicle ignition is activated, transmitting predetermined patterns and status information that allow the electronic control unit to synchronize its receiver circuitry and adjust equalization settings for the specific cable characteristics. Once the transition detection logic 110 within the electronic control unit observes that the encoded blocks no longer contain the training-mode-specific block identifier, the transition detection logic 110 may determine that the camera module has transitioned to data mode, and the electronic control unit may begin processing the incoming video data for display on the vehicle dashboard screen.

Referring to FIG. 2, an architecture 200 illustrating internal components of the transmitter 102 and the receiver 104 is shown. The architecture 200 depicts signal flow paths and processing components within the transmitter 102 and the receiver 104, which may be connected via the communication link 106. In various embodiments, the architecture 200 may enable the transmitter 102 and the receiver 104 to utilize a common frame structure and encoding path for both training mode and data mode operations.

The transmitter 102 may include a data input interface 202 configured to receive data for transmission. In some embodiments, the data input interface 202 may comprise an XGMII (10 Gigabit Media Independent Interface), a standard interface for transferring data between layers, or other suitable interface for transferring data and control signaling. The data input interface 202 may provide a mechanism for receiving data from higher protocol layers along with control information indicating whether incoming information comprises data or control signaling. In various implementations, the data input interface 202 may receive video data from an automotive camera sensor, sensor data from a radar or LiDAR unit, display data from an infotainment system, or other types of data suitable for transmission over the communication link 106.

The transmitter 102 may further include a mode control 204 associated with the frame generator 108. The mode control 204 may be configured to control the operational mode of the transmitter 102, determining whether the transmitter 102 operates in training mode or data mode. In some embodiments, the mode control 204 may receive status information from the receiver 104 via the communication link 106 and may determine when conditions are satisfied for transitioning from training mode to data mode. The mode control 204 may monitor local receiver status indicators and remote receiver status indicators to coordinate mode transitions between link partners.

The frame generator 108 may be coupled to the data input interface 202 and configured to generate frames using the unified frame structure for both training mode and data mode operations. The frame generator 108 may generate both training frames and data frames using a common encoding path and common framing logic. In some embodiments, the unified frame structure may comprise a 300-bit RS-FEC frame with RS-FEC(50,46,6) encoding, where 50 symbols are transmitted, 46 contain data, and 6 provide error correction. In various embodiments, the unified frame structure may comprise 260 bits allocated for four 64B/65B encoded blocks, 16 bits reserved for OAM (Operations, Administration, and Maintenance) functions, and 24 bits for FEC parity. The frame generator 108 may generate training frames during training mode wherein a first subset of the 64B/65B blocks, such as the first three blocks, contains predetermined data patterns and a fourth 64B/65B block of the four 64B/65B encoded blocks contains an information field encoded as a control block with a training-mode-specific block identifier.

With continued reference to FIG. 2, the transmitter 102 may include an encoder 206 configured to process frames generated by the frame generator 108. The encoder 206 may comprise a 64B/65B encoding 208 component and an RS-FEC encoder 210. The 64B/65B encoding 208 may perform 64B/65B block encoding on frame data. In 64B/65B encoding, the plurality of encoded blocks may comprise 64B/65B encoded blocks, and a control block may be encoded with a 65th bit set to one to indicate the control block. The 65th bit may serve as a control indicator bit that distinguishes whether the block contains data content or control information. When the 65th bit is set to zero, the block may contain data. When the 65th bit is set to one, the block may contain control information, such as the information field during training mode.

The RS-FEC encoder 210 may apply Reed-Solomon forward error correction encoding to the encoded blocks. The unified frame structure may further comprise forward error correction parity bits. In some embodiments, the forward error correction parity bits may comprise Reed-Solomon forward error correction encoding. The RS-FEC encoder 210 may implement RS-FEC(50,46,6) encoding, which may generate 24 parity bits for error correction. The presence of RS-FEC error correction may enable elimination of a CRC16 field from the information field, as the RS-FEC may provide sufficient error protection for the training information. In alternative embodiments, the system 100 may utilize other FEC schemes including Bose-Chaudhuri-Hocquenghem (BCH) codes, low-density parity-check (LDPC) codes, or other suitable error correction codes while maintaining the unified frame structure.

The transmitter 102 may further include a modulator 212 configured to receive encoded data from the encoder 206 and process the data for transmission using a selected signaling format. In some embodiments, the selected signaling format may include differential Manchester encoding during both training mode and data mode. The modulator 212 may process the RS-FEC encoded frame through a scrambler, followed by differential coding, and then Manchester coding to produce differential Manchester encoded symbols for transmission. By utilizing a consistent modulation scheme during both modes, the modulator 212 may eliminate the need for modulation reconfiguration during transitions from training mode to data mode. A transmitter PMA interface 214 may couple the modulator 212 to the communication link 106 for physical medium attachment. The transmitter PMA interface 214 may provide an electrical interface for transmitting modulated signals over the communication link 106, and may output differential Manchester encoded symbols to a PMA service interface.

The receiver 104 may include a receiver PMA interface 216 configured to couple to the communication link 106 for receiving transmitted signals. The receiver PMA interface 216 may provide an electrical interface for receiving signals from the communication link 106 and may include circuitry for signal conditioning, timing recovery, or other signal processing functions. A demodulator 218 may receive signals from the receiver PMA interface 216 and demodulate the received signals. In some embodiments, the demodulator 218 may be configured to demodulate differential Manchester encoded signals, corresponding to the modulation scheme utilized by the modulator 212 in the transmitter 102.

The receiver 104 may further include a decoder 220 configured to process demodulated signals. The decoder 220 may comprise an RS-FEC decoder 224 and a 64B/65B decoding component 222. The RS-FEC decoder 224 may perform Reed-Solomon forward error correction decoding on received data, detecting and correcting errors that may have occurred during transmission. The 64B/65B decoding 222 may perform 64B/65B block decoding on decoded data, extracting payload content from each encoded block and interpreting the control indicator bit to determine whether each block contains data or control information.

The transition detection logic 110 may be coupled to the decoder 220. The transition detection logic 110 may detect a transition from training mode to data mode based on observing a change in content of encoded blocks within received frames. In some embodiments, the transition detection logic 110 may monitor the 65th bit and block identifier of one or more 64B/65B blocks to determine whether the block contains the training-mode-specific block identifier or data mode content.

A frame processing logic 226 may be coupled to the transition detection logic 110 and configured to process decoded frames. The frame processing logic 226 may extract payload data from decoded frames and may process information field content during training mode to coordinate link establishment with the transmitter 102. A data output interface 228 may receive processed data from the frame processing logic 226 and output the data from the receiver 104. In some embodiments, the data output interface 228 may comprise an XGMII interface or other suitable interface for transferring received data and control signaling to higher protocol layers.

The architecture 200 may enable common encoding paths for both training and data modes. The frame generator 108 may generate both training frames and data frames using the unified frame structure, and the encoder 206 may process both frame types using the 64B/65B encoding 208 and RS-FEC encoder 210 components. Similarly, the decoder 220 in the receiver 104 may process both training frames and data frames using the RS-FEC decoder 224 and 64B/65B decoding 222 components. This common encoding path may enable hardware reuse between training and data mode operations, potentially reducing silicon area requirements and implementation cost compared to approaches that employ separate encoding and decoding circuitry for training and data modes.

Referring to FIG. 3, a format 300 of an information field training structure is depicted. The format 300 illustrates the structure of an information field encoded within a 64B/65B control block during training mode. As described previously, during the training mode, the transmitter 102 may generate training frames in which at least one of the plurality of encoded blocks contains an information field encoded as a control block with a training-mode-specific block identifier. The format 300 may arrange fields linearly as a data structure spanning octet positions 0 through 8.

At position 0, the format 300 may include a field containing a block identifier value, such as 0xBB, which serves as the training-mode-specific block identifier. In some embodiments, the block identifier may comprise the first byte of an Infofield as defined in 802.3ch and may be distinct from block identifiers defined in a 64B/65B block format table, such as the 64B/65B block formats for MultiGBASE-T1 in 802.3ch. In various embodiments, the value 0xBB may be selected because it corresponds to the first byte of the 802.3ch Infofield and because it differs from the Block IDs for all entries in the 64B/65B block formats for MultiGBASE-T1 defined in 802.3ch. In other embodiments, the training-mode-specific block identifier may comprise any suitable block identifier value that is distinct from block identifiers used during data mode operations, enabling the receiver 104 to distinguish training frames from data frames based on the block identifier content.

The format 300 may further include a partial frame count field, such as a PFC24 field, extending from position 0 to position 4. The partial frame count field may contain a frame count value used for frame synchronization during training mode operations. A message field may be positioned at locations 4 to 5 within the format 300. The information field may comprise status bits for communicating training completion readiness between link partners. In some embodiments, the message field may contain physical medium attachment state bits, a local receiver status indicator, a slave transmitter enable indicator for master devices, and a timing lock indicator for slave devices. The slave transmitter enable indicator may be set by a master device to signal to a slave device that the slave device is permitted to begin transmitting training frames. In some embodiments, when the master device sets the slave transmitter enable indicator to one, the slave device may initiate transmission of training frames on the communication link. The timing lock indicator may be set by a slave device to indicate that timing synchronization with the master device has been achieved. In various embodiments, the slave device may set the timing lock indicator to one when the slave device has successfully locked onto the timing of the signal transmitted by the master device. The status bits may comprise a local receiver status indicator that is set when a local receiver has completed training and is ready to transition to the data mode. The local receiver status indicator may be set to indicate that the local receiver has successfully completed training operations and is prepared to receive data frames.

A capability bits field may extend from position 5 to position 8 within the format 300. In some embodiments, physical layer capability bits may be encoded in one or more octets of the information field, including VendorSpecificData fields and reserved bits. The VendorSpecificData fields may provide dedicated bit positions that vendors may use to communicate proprietary capabilities, features, or configuration parameters between link partners during training mode. In various embodiments, the VendorSpecificData fields may enable manufacturers to implement custom functionality, such as proprietary power management features, enhanced diagnostic capabilities, or vendor-specific performance optimizations, while maintaining compatibility with the unified frame structure and standard training procedures. The VendorSpecificData fields may occupy octets 8 and 9 of the information field, providing a total of 16 bits that vendors may use to communicate proprietary capabilities or features between link partners during training mode. In various embodiments, the VendorSpecificData fields may enable vendor-specific extensions that allow manufacturers to implement custom functionality while maintaining compatibility with the unified frame structure. Octet 10 of the capability bits field may contain additional fields including reserved bits, interleaver depth settings, precoder selection bits, slow wake request indicators, Energy Efficient Ethernet enable bits, and OAM enable bits. The capability bits field may indicate physical layer capabilities of the device, enabling link partners to exchange capability information during training mode.

In some embodiments, the information field structure depicted in the format 300 may be derived from a standard Infofield format with octets 2, 3, 11, and 12 removed. Octets 11 and 12 may contain a cyclic redundancy check field, such as a CRC16 field, that may be eliminated due to the presence of forward error correction, which may provide sufficient error protection for the training information. The removal of octets 2 and 3 may further reduce the information field size to fit within the 64B/65B block structure. The format 300 may encode training information within a 64B/65B control block structure, enabling the training information to be carried within the same unified frame structure used for data mode transmission. During the training mode, the transmitter 102 may transmit training frames in which at least one of the plurality of encoded blocks contains the information field encoded as a control block with the training-mode-specific block identifier, as illustrated by the format 300.

Referring to FIG. 4, a format 400 of an Infofield countdown structure is depicted. The format 400 illustrates the structure of an information field encoded within a 64B/65B control block during a countdown phase of training mode. The format 400 may arrange fields horizontally in sequence from left to right, spanning octet positions 0 through 8.

At position 0, the format 400 may include a field containing a block identifier value, such as 0xBB, which serves as the training-mode-specific block identifier. The block identifier in the format 400 may be the same block identifier used in the format 300 for training mode, maintaining consistency in how the receiver 104 identifies training-related frames. A partial frame count field may extend from position 0 to position 4 within the format 400. The partial frame count field may contain a frame count value used for frame synchronization during countdown operations.

A message field may be positioned at locations 4 to 5 within the format 400. The message field may contain status bits including physical medium attachment state bits set to a countdown value, a local receiver status indicator, and other receiver status and control information. In various embodiments, the local receiver may set the local receiver status indicator (loc_rcvr_status) when the local receiver has completed training operations and is ready to transition to data mode. This local receiver status indicator may be transmitted to the remote link partner via the information field within training frames. Similarly, the remote link partner may communicate its own receiver status back through the information field, enabling each device to be aware of the other device’s training completion status. The transition from training mode to data mode may occur when both local and remote receiver status indicators confirm readiness through bidirectional status confirmation. This bidirectional confirmation mechanism may ensure that both receivers have successfully completed training before either device transitions to data mode, which may prevent data loss that could otherwise occur if one device transitioned before the other device was prepared to receive data frames. The local receiver status indicator may be set when the local receiver has completed training, and the remote receiver status may be communicated via the information field to the link partner, enabling both link partners to coordinate the transition to data mode.

A data switch partial frame count field may extend from position 5 to position 8 within the format 400. The data switch partial frame count field may indicate a partial frame count at which a transmitter will switch from training mode to data mode. In some embodiments, the system 100 may retain an optional countdown mechanism within the information field for backward compatibility while still using content-based transition detection as a primary mechanism. The transition detection logic 110 in the receiver 104 may detect the transition from training mode to data mode by observing the absence of the training-mode-specific block identifier in the encoded blocks, regardless of whether the countdown mechanism is present in the information field. This approach may enable the system 100 to maintain compatibility with link partners that utilize countdown-based transition coordination while benefiting from the simplified content-based transition detection mechanism.

Referring to FIG. 5, a view 500 comparing a training frame 502 and a data mode frame 504 is depicted. The training frame 502 and the data mode frame 504 may share the unified frame structure described previously. In some embodiments, the training frame 502 may be designated as a 100M SEND_T RS-FEC Training Frame and may comprise a plurality of fields arranged in sequence, including three fields containing zeros, an Info/Countdown field, a Reserved field, and an FEC Parity field. The data mode frame 504 may be designated as a 100M SEND_N RS-FEC Encoded Frame and may comprise a plurality of fields arranged in sequence, including four 64B/65B encoded blocks designated as 65B #1, 65B #2, 65B #3, and 65B #4, followed by a Reserved field and an FEC Parity field. The training frame 502 and the data mode frame 504 may differ in content rather than in structural organization.

As illustrated in the view 500, during the training mode, a subset of the plurality of encoded blocks may contain predetermined data patterns configured to facilitate receiver synchronization. In the training frame 502, the first three 64B/65B blocks contain all-zero data blocks, and the fourth 64B/65B block contains the information field encoded as a control block with the training-mode-specific block identifier. The all-zero data blocks in the first three 64B/65B blocks may be scrambled prior to transmission such that the all-zero data blocks are not transmitted as all zeros on the communication medium. The scrambling operation may randomize the bit patterns to improve signal characteristics during transmission while enabling the receiver 104 to recognize the predetermined patterns following descrambling operations.

In alternative embodiments, the predetermined data patterns for receiver synchronization may comprise pseudorandom binary sequences rather than all-zero data blocks. In other embodiments, the predetermined data patterns for receiver synchronization may comprise alternating one-zero patterns or other suitable sequences. The selection of predetermined data patterns may be based on requirements of the communication system, including considerations such as signal spectral characteristics, receiver synchronization performance, and compatibility with applicable standards. Regardless of the specific predetermined data pattern employed, the unified frame structure may maintain a consistent arrangement of encoded blocks, reserved fields, and forward error correction parity fields for both training frames and data frames.

With continued reference to FIG. 5, the transmitter 102 may transition from the training mode to the data mode by modifying payload content of the frames while maintaining the unified frame structure. As depicted in the view 500, the transition from the training frame 502 to the encoded frame 504 may involve changing the content of the encoded blocks from predetermined data patterns and the information field to 64B/65B encoded data blocks, while the overall frame structure remains consistent. The Reserved field and the FEC Parity field may occupy corresponding positions in both the training frame 502 and the encoded frame 504, illustrating that the unified frame structure may be maintained across both operational modes. This approach may enable the frame generator 108 to utilize common framing logic for generating both training frames and data frames, as the frame structure may remain unchanged during the transition from training mode to data mode.

Referring to FIG. 6, a view 600 of a block 602 structure used in 64B/65B encoding is depicted. The block 602 illustrates the format of an encoded block within the unified frame structure. The block 602 may comprise three fields arranged in sequence. A field 604 may occupy a first portion of the block 602 and may contain a control indicator bit. A field 606 may follow the field 604, and together with the field 604, may form a Block ID having a total of 8 bits. A field 608 may occupy the remaining portion of the block 602 and may constitute a Payload/Information Field having 56 bits.

In some embodiments, the information field may be encoded using a data block with a reserved data pattern rather than a control block. In such embodiments, the field 604 may contain a value of zero to indicate a data block, and the field 608 may contain a reserved data pattern that is recognizable by the receiver 104 as carrying training information. The reserved data pattern may comprise a predetermined sequence of bits that is distinct from patterns used during normal data transmission. This configuration may enable the transition detection logic 110 to identify training frames based on the reserved data pattern content rather than the control indicator bit value. In other embodiments, other suitable encoding approaches may be employed to convey training information within the unified frame structure while maintaining structural consistency between training frames and data frames.

Referring to FIG. 7, a view 700 of a 64B/65B control block structure used for encoding an information field during training mode is depicted. The view 700 illustrates a block format comprising a total of 65 bits per block. A 1-bit control indicator bit is positioned at the leftmost position, with a value of one indicating that the block is a control block. An 8-bit block identifier field follows the control indicator bit, with the block identifier being training-mode-specific and having a value such as 0xBB. A 56-bit payload/information field occupies the remaining portion of the block structure, providing space for training-related information including status bits and capability data. The view 700 demonstrates how the information field is encoded within a standard 64B/65B block format, where the 65th bit set to one distinguishes this control block from data blocks used during normal data transmission.

The control block structure depicted in the view 700 enables the information field to be transmitted using the block encoding scheme employed during data mode operations. By encoding the information field within the standard 64B/65B block format, the transmitter 102 utilizes the same 64B/65B encoding component 208 for processing both training frames and data frames. The 8-bit block identifier serves as the training-mode-specific block identifier that enables the transition detection logic 110 in the receiver 104 to distinguish training frames from data frames based on the block identifier content. In various embodiments, the block identifier value may comprise 0xBB or other suitable values that are distinct from block identifiers used during data mode operations.

In some embodiments, the information field may be distributed across multiple encoded blocks of the plurality of encoded blocks rather than being contained in a single block. When the information field is distributed across multiple encoded blocks, each of the multiple encoded blocks contains a portion of the training-related information, and the receiver 104 reassembles the distributed information field from the multiple encoded blocks during frame processing. This distributed encoding approach provides flexibility in accommodating information fields of varying sizes and may enable redundant encoding of training information across multiple blocks for enhanced reliability. In other embodiments, the information field may be contained within a single encoded block, or may be organized according to other suitable arrangements within the unified frame structure.

In alternative embodiments, status information may be encoded in reserved OAM bits instead of or in addition to the information field for status communication between link partners. The reserved OAM bits within the unified frame structure provide an alternative location for conveying receiver status, training completion readiness, or other status information during training mode operations. When status information is encoded in the reserved OAM bits, the 56-bit payload/information field within the control block structure may be utilized for other training-related data including capability information, synchronization parameters, or other suitable content.

In various embodiments, any one or more of the following features may be implemented independently or in combination: use of a unified frame structure in training mode and data mode; encoding of training information within a control block of a block-based encoding scheme used for data mode; content-based detection of a training-to-data transition; use of a same modulation or signaling format in training mode and data mode; omission of one or more intermediate state-machine states between training and data transmission; and reuse of common framing logic or common encoding circuitry across training mode and data mode.

Referring to FIG. 8, a comparison between a conventional state flow 800 and a simplified state flow 820 for PHY control processes is illustrated. The conventional state flow 800 depicts a sequence of states employed in conventional PHY control implementations, while the simplified state flow 820 depicts a reduced sequence of states enabled by the unified frame structure described herein.

The conventional state flow 800 may comprise a block 802 representing a DISABLE_TRANSMITTER state, a block 804 representing a SILENT state, a block 806 representing a TRAINING state, a block 808 representing a COUNTDOWN state, a block 810 representing a TX_SWITCH state, a block 812 representing a PCS_TEST state, and a block 814 representing a PCS_DATA state. In the conventional state flow 800, the block 808 representing the COUNTDOWN state may provide advance notification to the receiver 104 of an impending mode transition. The block 810 representing the TX_SWITCH state may be configured to manage modulation format changes between training mode and data mode. The block 812 representing the PCS_TEST state may be configured to verify that encoding and decoding functions are operating correctly following a mode change.

The simplified state flow 820 may comprise a block 822 representing a DISABLE_TRANSMITTER state, a block 824 representing a SILENT state, a block 826 representing a TRAINING state, and a block 828 representing a PCS_DATA state. In various embodiments, the system 100 may comprise a state machine having a training state and a data transmission state. The block 826 may correspond to the training state, and the block 828 may correspond to the data transmission state. In the simplified state flow 820, the training state and the data transmission state may be configured as consecutive states in the state machine, enabling direct transition between these states.

The comparison between the conventional state flow 800 and the simplified state flow 820 illustrates that the unified frame structure enables elimination of the block 808 representing the COUNTDOWN state, the block 810 representing the TX_SWITCH state, and the block 812 representing the PCS_TEST state. In various embodiments, the state machine may be configured to transition from the training state to the data transmission state without requiring an intermediate countdown state, a TX switch state, or a PCS test state. The state machine may transition from the training state to the data transmission state while eliminating at least one of a countdown state, a TX switch state, or a PCS test state. The elimination of these intermediate states may be enabled by the unified frame structure and the content-based transition detection mechanism, wherein the transition detection logic 110 may detect the transition from training mode to data mode by observing the change in content of the encoded blocks rather than requiring explicit countdown synchronization.

In some embodiments, the state machine may retain one or more of the eliminated states while still benefiting from the unified frame structure. For example, the state machine may retain the countdown state for backward compatibility with link partners that utilize countdown-based transition coordination while eliminating the TX switch state and the PCS test state. In other embodiments, the state machine may retain the PCS test state for verification purposes while eliminating the countdown state and the TX switch state. The unified frame structure may provide various benefits including hardware reuse between training and data modes regardless of whether all intermediate states are eliminated, as the same framing logic and encoding paths may be utilized for both operational modes.

Referring to FIG. 9, a state diagram 900 for a PHY control process is illustrated. The state diagram 900 depicts a simplified state machine architecture configured to manage transitions between operational states during link establishment and data transmission. The state diagram 900 includes the block 822, the block 824, the block 826, and the block 828, which may correspond to the DISABLE_TRANSMITTER state, the SILENT state, the TRAINING state, and the PCS_DATA state, respectively. A transition 902, a transition 904, a transition 906, and a transition 908 connect the blocks 822, 824, 826, and 828 to define the state flow within the state diagram 900.

The transition 902 leads to the block 822, which may be designated as DISABLE_TRANSMITTER. In various embodiments, the transition 902 may occur when one or more conditions are satisfied. Such conditions may include a link_control signal equaling DISABLE in conjunction with auto_neg_imp and mr_autoneg_enable signals, a sync_link_control signal equaling DISABLE in conjunction with negated auto_neg_imp or negated mr_autoneg_enable signals, or a pma_reset signal equaling ON. Within the block 822, a pcs_data_mode indicator may be set to FALSE, which may indicate that the transmitter 102 is not operating in data transmission mode. In some embodiments, the link_control signal may comprise a control input configured to determine whether the communication link 106 is enabled or disabled. The sync_link_control signal may comprise a synchronized version of the link control input. The pma_reset signal may comprise a reset input for the physical medium attachment layer.

The transition 904 connects the block 822 to the block 824, which may be designated as SILENT. In some embodiments, the transition 904 may occur when the link_control signal equals ENABLE in conjunction with auto_neg_imp and mr_autoneg_enable signals, or when the sync_link_control signal equals ENABLE in conjunction with negated auto_neg_imp or negated mr_autoneg_enable signals. Within the block 824, a tx_mode indicator may be set to SEND_Z, and a minwait_timer may be initiated. The SEND_Z mode may indicate that the transmitter 102 is transmitting a silent or idle pattern on the communication link 106. In various embodiments, the minwait_timer may comprise a timer configured to enforce a minimum wait period before the state machine proceeds to a subsequent state.

The transition 906 connects the block 824 to the block 826, which may be designated as TRAINING. In various embodiments, the transition 906 may occur when configuration settings and receiver status indicators satisfy one or more specified conditions. For example, the transition 906 may occur when a config indicator equals MASTER. Alternatively, the transition 906 may occur when the config indicator equals SLAVE in conjunction with a loc_SNR_margin indicator equaling OK and an en_slave_tx indicator equaling one, provided that a minwait_timer_done indicator is true. The config indicator may specify whether the device operates as a master or slave in the communication link 106. The loc_SNR_margin indicator may indicate whether the local signal-to-noise ratio margin is acceptable for training operations. The en_slave_tx indicator may indicate whether slave transmission has been enabled by the master device. Within the block 826, the tx_mode indicator may be set to SEND_T, the minwait_timer may be initiated, and a PMA_state indicator may be set to 00. The SEND_T mode may indicate that the transmitter 102 is transmitting training frames using the unified frame structure.

The transition 908 connects the block 826 to the block 828, which may be designated as PCS_DATA. In some embodiments, the transition 908 may occur when receiver status indicators confirm that both link partners have completed training and are ready to transition to data mode. For example, the transition 908 may occur when a loc_rcvr_status indicator equals OK, a rem_rcvr_status indicator equals OK, the minwait_timer_done indicator is true, and an infofield_complete indicator is true. The loc_rcvr_status indicator may comprise the local receiver status indicator described previously, which may be set when the local receiver has completed training and is ready to transition to data mode. The rem_rcvr_status indicator may indicate the status of the remote receiver, which may be communicated via the information field within training frames. The infofield_complete indicator may indicate that the information field exchange between link partners has been completed. Within the block 828, the pcs_data_mode indicator may be set to TRUE, which may indicate that the transmitter 102 is operating in data transmission mode.

As illustrated in the state diagram 900, the state machine may be configured to transition directly from the block 826 representing the training state to the block 828 representing the data transmission state via the transition 908. In various embodiments, the state diagram 900 may not include intermediate countdown, TX switch, or PCS test states between the training state and the data transmission state. This direct transition may be enabled by the unified frame structure and the content-based transition detection mechanism described previously. The transition detection logic 110 in the receiver 104 may detect the transition from training mode to data mode by observing the absence of the training-mode-specific block identifier in the encoded blocks, which may eliminate the need for explicit countdown synchronization that would otherwise require intermediate states. The use of a consistent modulation scheme during both training mode and data mode may eliminate the need for a TX switch state that would otherwise be required to coordinate modulation format changes. In some embodiments, because the system does not switch modulation between training and data modes and because the unified frame structure maintains consistent framing throughout both modes, there may be no frame structure reconfiguration to verify, thereby eliminating the need for the PCS test state that would otherwise be required to verify successful reconfiguration following a mode change.

Referring to FIG. 10, a view 1000 illustrating a transition between a training mode frame 1002 and a data mode frame 1006 is depicted. The training mode frame 1002 may be designated as SEND_T and may comprise a plurality of fields arranged in sequence. In various embodiments, the training mode frame 1002 may include three fields each containing zero data patterns (65b), followed by a field 1004 containing an information field with a block identifier such as 0xBB and a D/C indicator set to one, a Reserved field, and an FEC Parity field. The data mode frame 1006 may be designated as SEND_N and may comprise a plurality of fields arranged in sequence. In some embodiments, the data mode frame 1006 may include four 65B encoded blocks designated as 65B #1 (data), 65B #2 (data), 65B #3 (data), and a field 1008 containing 65B #4 (data) with a D/C indicator set to zero, followed by a Reserved field and an FEC Parity field. A Transition 1010 may separate the training mode frame 1002 from the data mode frame 1006, indicating the point at which the system 100 transitions from training mode to data mode.

In the training mode frame 1002, the field 1004 may represent the information field encoded as a control block with the D/C indicator set to one. The D/C indicator set to one may indicate that the field 1004 contains training information, which may include status bits and capability data as described previously. In various embodiments, the D/C indicator set to one may correspond to the 65th bit of the 64B/65B encoded block being set to one, designating the block as a control block rather than a data block. In the data mode frame 1006, the field 1008 may represent data content with the D/C indicator set to zero. The D/C indicator set to zero may indicate that the field 1008 contains user data rather than control information. In some embodiments, the D/C indicator set to zero may correspond to the 65th bit of the 64B/65B encoded block being set to zero, designating the block as a data block.

The transition detection logic 110 in the receiver 104 may detect the transition from training mode to data mode based on one or more observable changes in the received frames. In some embodiments, the transition detection logic 110 may observe the change in content between the field 1004 and the field 1008. In other embodiments, the transition detection logic 110 may monitor the D/C indicator, which may switch from one to zero when transitioning from training mode to data mode. In still other embodiments, the receiver 104 may detect the transition based on observing data content different from the predetermined training pattern in encoded blocks that contained predetermined data patterns during the training mode. The transition detection logic 110 may observe that the encoded blocks that previously contained the predetermined training pattern now contain data content different from the predetermined training pattern, thereby detecting that the transmitter 102 has transitioned from training mode to data mode.

In alternative embodiments, the transition detection may be based on detecting the presence of data-mode-specific block identifiers rather than the absence of training-mode-specific block identifiers. In such embodiments, the transition detection logic 110 may monitor the block identifier field within the encoded blocks and may detect the transition when a data-mode-specific block identifier appears in a position that previously contained the training-mode-specific block identifier. Other suitable approaches for detecting mode transitions may be employed while maintaining the content-based transition detection capability enabled by the unified frame structure.

Referring to FIG. 11, a method 1100 for generating and transmitting frames using a unified frame structure is illustrated. The method 1100 depicts a sequence of operations that may be performed by the transmitter 102 to generate and transmit frames during both training mode and data mode operations. In various embodiments, the method 1100 may be implemented by the frame generator 108 within the transmitter 102, utilizing the encoder 206 and modulator 212 components described previously with reference to FIG. 2. In other embodiments, the method 1100 may be implemented by other suitable processing components or combinations of hardware and software elements within the transmitter 102.

At a block 1102, the method 1100 may generate frames using the unified frame structure for both a training mode and a data mode. The unified frame structure may comprise a plurality of encoded blocks, and the transmitter 102 may use a same modulation scheme during both the training mode and the data mode. In some embodiments, the frame generator 108 may generate frames using a common encoding path and common framing logic for both training frames and data frames. In other embodiments, the frame generator 108 may utilize separate encoding paths that produce structurally consistent output frames. The block 1102 may represent an initialization or configuration operation wherein the frame generator 108 is configured to utilize the unified frame structure for subsequent frame generation operations. In alternative embodiments, the block 1102 may represent a continuous frame generation process that operates throughout both training mode and data mode.

At a block 1104, the method 1100 may transmit training frames during the training mode. During the training mode, the frame generator 108 may generate training frames in which at least one of the plurality of encoded blocks contains an information field encoded as a control block with a training-mode-specific block identifier. The information field may be encoded within a 64B/65B control block with the 65th bit set to one and a block identifier such as 0xBB that is distinct from block identifiers used during data mode operations, as described previously with reference to FIGS. 3, 6, and 7. In other embodiments, the information field may be encoded using other suitable block identifiers or encoding formats that distinguish training content from data content. The training frames may include predetermined data patterns in a subset of the encoded blocks for receiver synchronization, as described previously with reference to FIG. 5. In alternative embodiments, the training frames may include other suitable patterns or content arrangements that facilitate receiver synchronization and link establishment.

At a block 1106, the method 1100 may transmit data frames during the data mode. During the data mode, the transmitter 102 may generate data frames using the unified frame structure with data content in the plurality of encoded blocks. The frame generator 108 may populate the encoded blocks with user data rather than training information. The transmitter 102 may transition from the training mode to the data mode by modifying payload content of the frames while maintaining the unified frame structure. In some embodiments, the transition may occur in response to status indicators confirming that both link partners have completed training operations. In other embodiments, the transition may be triggered by other suitable conditions or coordination mechanisms.

The sequence of operations in the method 1100 may maintain structural consistency between training mode and data mode operations. By utilizing the same underlying frame structure for both training frames and data frames, the method 1100 may enable hardware reuse between training and data modes. The frame generator 108 may utilize common framing logic and encoding paths for generating both frame types, as the distinction between training frames and data frames may be determined by the content within the encoded blocks rather than by differences in the frame structure. The transition detection logic 110 in the receiver 104 may detect the transition from training mode to data mode by observing the change in content of the encoded blocks, as described previously with reference to FIG. 10. In other embodiments, the receiver 104 may employ other suitable detection mechanisms that leverage the unified frame structure to identify mode transitions.

In various embodiments, the method 1100 and the unified frame structure concepts described herein may be applied to communication systems operating at different data rates and to other point-to-point communication architectures that employ a training phase followed by a data transmission phase. In such implementations, frame sizes, block sizes, coding schemes, modulation formats, and field allocations may differ from the specific examples described herein, while maintaining the principle that training communication is carried using a frame structure that is structurally consistent with a data-mode frame structure and that a transition to data mode may be detected based on content changes within one or more encoded blocks. The particular protocols, symbol mappings, coding parameters, and state-machine arrangements may vary according to implementation.

As described in the foregoing disclosure, embodiments of the present disclosure may provide various benefits over conventional approaches. In various embodiments, a unified frame structure for training and data mode communication may simplify physical layer implementation by structuring the training frame as a special case of the data mode frame. In some embodiments, both training and data modes may use the same frame structure comprising a plurality of encoded blocks, with the training frame differing from the data frame in content rather than structure. During training mode, at least one encoded block may contain an information field encoded as a control block with a training-mode-specific block identifier, while a subset of encoded blocks may contain predetermined data patterns for receiver synchronization. In various embodiments, the receiver may detect the transition from training mode to data mode by observing the change in content of the encoded blocks, such as the absence of the training-mode-specific block identifier. By using the same modulation scheme during both training and data modes, embodiments of the present disclosure may eliminate or reduce the need for modulation reconfiguration and may enable a simplified state machine architecture that transitions directly from a training state to a data transmission state without requiring intermediate countdown, TX switch, or PCS test states. In some embodiments, this approach may enable hardware reuse between training and data modes, may reduce silicon area and implementation cost, and may simplify the training-to-data transition.

The foregoing description has presented illustrative, non-limiting examples and embodiments to facilitate understanding of the disclosed systems and methods for unified frame structure for training and data mode communication. Example implementations, architectures, frame structures, encoding schemes, and component arrangements have been provided for clarity and may be combined, omitted, substituted, or modified unless a particular feature is expressly stated as required in a given context.

Throughout this disclosure, device roles may be described using “master” and “slave” terminology consistent with referenced standards. Equivalent terminology such as “leader” and “follower” may also be used, with “leader” corresponding to “master” and “follower” corresponding to “slave.” The term “configured to” describes hardware, software, firmware, or combinations thereof that are arranged, programmed, or otherwise provisioned to perform a stated function, and refers to capability resulting from structure or programming rather than mere intended use. The term “coupled” indicates direct or indirect interaction, association, or communication, including electrical, logical, data, or signal coupling, with or without intervening elements, and encompasses both wired and wireless connections unless specified otherwise. The terms “about” or “approximately” indicate a value within normal engineering, measurement, or numerical tolerance for the context, and unless otherwise specified, “about” may encompass ±10 % of the stated value or a tolerance appropriate to the resolution or precision stated. Numeric ranges are inclusive of endpoints and include all subranges and intermediate values, and where a range is recited with “about,” the approximation applies to endpoints and intermediate values unless otherwise indicated. Terms such as “optional,” “optionally,” and “may” indicate that a feature, step, or parameter can be present or absent, or enabled or disabled, without implying that alternatives are excluded, and optional features can be used individually or in any combination.

Reference numerals and figure conventions have been applied as follows: The same reference numeral refers to the same or functionally equivalent element across figures, and suffixes or primes may denote variants, instances, or related elements. Drawings are schematic and not necessarily to scale unless expressly indicated, and relative sizes and spatial relationships may be exaggerated for clarity. Block diagrams depict functionality or logical groupings, and a single block may represent multiple components or functions while multiple blocks may be implemented within a single component. Flowchart steps may be performed in different orders, in parallel, iteratively, or with steps added or omitted, unless a particular order is expressly required. State machine transitions may occur in response to various conditions as described, and intermediate states may be added or omitted in alternative implementations.

Units and conventions have been used as follows: International System of Units (SI) units are used unless stated otherwise. Computing quantities may use standard units such as bits, bytes, or blocks. This disclosure expresses data rates in megabits per second (Mbps) or gigabits per second (Gbps). Time is expressed in seconds (s) or derivatives thereof. Frequencies are expressed in hertz (Hz). Frame sizes, block sizes, and field lengths are expressed in bits unless otherwise noted. References to “training mode” and “data mode” indicate operational phases of link establishment and data transmission, respectively. References to “upstream” and “downstream” or “transmitter” and “receiver” indicate signal flow directionality in the communication link.

Cross-references to figures have been provided for illustrative context. Figure numbers do not imply priority, sequence, or exclusivity. Components shown in different figures may be combined or substituted as technically appropriate.

These conventions have been applied throughout the Detailed Description, including descriptions of unified frame structures, 64B/65B encoding, training-mode-specific block identifiers, information field encoding, state machine transitions, content-based transition detection, modulation schemes, and variants and equivalents thereof.

A number of implementations have been described. Nevertheless, it will be understood that various modifications may be made without departing from the spirit and scope of the disclosure. Accordingly, other implementations are within the scope of the following claims.

What is claimed is:

1. A system comprising:
a transmitter that generates frames using a unified frame structure for both a training mode and a data mode, wherein:
the unified frame structure comprises a plurality of encoded blocks;
the transmitter uses a same modulation scheme during both the training mode and the data mode;
during the training mode, the transmitter generates training frames in which at least one encoded block of the plurality of encoded blocks contains an information field encoded as a control block with a training-mode-specific block identifier; and
during the data mode, the transmitter generates data frames using the unified frame structure with data content in at least a subset of the plurality of encoded blocks; and
a receiver that receives the generated frames and detects a transition from the training mode to the data mode based on detecting a content change in the at least one encoded block of the plurality of encoded blocks.

2. The system of claim 1, wherein at least one of the transmitter or the receiver comprises a state machine comprising a training state and a data transmission state, wherein the training state and the data transmission state are consecutive states in the state machine, and wherein the state machine transitions from the training state to the data transmission state without the state machine including, between the training state and the data transmission state, at least one of a countdown state, a transmitter switch state, or a physical coding sublayer test state.

3. The system of claim 1, wherein at least one of the transmitter or the receiver comprises a state machine comprising a training state and a data transmission state, wherein the state machine transitions from the training state to the data transmission state while eliminating at least one of: a countdown state, a transmitter switch state, or a physical coding sublayer test state.

4. The system of claim 1, wherein the unified frame structure further comprises forward error correction parity bits.

5. The system of claim 4, wherein the forward error correction parity bits are generated using at least one of Reed-Solomon encoding, Bose-Chaudhuri-Hocquenghem encoding, or low-density parity-check encoding.

6. The system of claim 1, wherein during the training mode, a subset of the plurality of encoded blocks distinct from the at least one encoded block contains predetermined data patterns for receiver synchronization.

7. The system of claim 1, wherein the information field comprises status bits for communicating training completion readiness between link partners.

8. The system of claim 7, wherein the status bits comprise a local receiver status indicator that is set when the receiver has completed training and is ready to transition to the data mode.

9. The system of claim 1, wherein the transmitter transitions from the training mode to the data mode by changing content of the at least one encoded block from the information field to data content while maintaining the unified frame structure.

10. The system of claim 1, wherein the at least one encoded block comprises multiple encoded blocks, and wherein the information field is distributed across the multiple encoded blocks such that each of the multiple encoded blocks contains a respective portion of the information field.

11. The system of claim 1, wherein the receiver detects the transition based on observing that a subset of the plurality of encoded blocks that contained predetermined data patterns during the training mode contains non-zero data content during the data mode, the subset being distinct from the at least one encoded block.

12. The system of claim 1, wherein the receiver detects the transition from the training mode to the data mode without requiring countdown synchronization with the transmitter.

13. A method comprising:
generating, by a transmitter, frames using a unified frame structure comprising a plurality of encoded blocks for both a training mode and a data mode, wherein the transmitter uses a same modulation scheme for generating frames during both the training mode and the data mode;
during the training mode, transmitting training frames in which at least one encoded block of the plurality of encoded blocks contains an information field encoded as a control block with a training-mode-specific block identifier; and
during the data mode, transmitting data frames using the unified frame structure with data content in at least a subset of the plurality of encoded blocks.

14. The method of claim 13, wherein the at least one encoded block comprises multiple encoded blocks, and wherein the information field is distributed across the multiple encoded blocks such that each of the multiple encoded blocks contains a respective portion of the information field.

15. The method of claim 13, wherein during the training mode, a subset of the plurality of encoded blocks contains predetermined data patterns for receiver synchronization, the subset being distinct from the at least one encoded block that contains the information field.

16. The method of claim 13, wherein the unified frame structure further comprises forward error correction parity bits.

17. A transmitter comprising:
a frame generator configured to generate frames using a unified frame structure comprising a plurality of encoded blocks for both a training mode and a data mode, wherein:
the frame generator uses a same modulation scheme for generating frames during both the training mode and the data mode;
during the training mode, the frame generator generates training frames in which at least one encoded block of the plurality of encoded blocks contains an information field encoded as a control block with a training-mode-specific block identifier, and a subset of the plurality of encoded blocks distinct from the at least one encoded block contains predetermined data patterns; and
during the data mode, the frame generator generates data frames using the unified frame structure with data content in at least a subset of the plurality of encoded blocks.

18. The transmitter of claim 17, wherein the predetermined data patterns comprise all-zero data blocks.

19. The transmitter of claim 17, wherein each encoded block of the plurality of encoded blocks comprises a data portion and a control indicator bit that distinguishes data blocks from control blocks, and wherein the plurality of encoded blocks comprises 64B/65B encoded blocks with the control block encoded with a 65th bit set to one to indicate the control block.

20. The transmitter of claim 17, wherein the frame generator generates both the training frames and the data frames using a common encoding path and common framing logic.
